(19) United States
(12) Patent Application Publication
(10) Pub. No.: US 2010/0003341 A1
(43) Pub. Date: Jan. 7, 2010

(54) COMPOSITION WITH A BACTERICIDAL, FUNGICIDAL, VIRICIDAL AND INSECTICIDAL ACTION AND COMPOSITION ACTING AS A REPELLENT

(76) Inventor: Thomas Besendorfer, Niederneuching (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/997,735

(22) PCT Filed: Jun. 29, 2006
(86) PCT No.: PCT/EP06/06331

§ 371 Date: Sep. 29, 2008

(30) Foreign Application Priority Data
Aug. 2, 2005 (EP) EP2005/008360

(51) Int. Cl. A01N 59/00; A01N 37/16; A01P 1/00; A01P 17/00; A01P 7/04

(52) U.S. Cl. 424/616; 514/625

(57) ABSTRACT

A composition is disclosed which is characterized by a special combination of one or more disinfecting substances and one or more stabilizing substances. The composition is useful as a disinfectant. The composition may additionally include one or more insecticidal substances for use as an insecticide.

The invention at hand pertains to compositions, which is characterized by a combination of certain disinfecting and stabilizing substances. Furthermore, the invention at hand also pertains to compositions, which in addition include insecticidal, emulsifying or respectively solubilizing substances, and substances, which keep moist and/or gelatinize.

Furthermore, the invention at hand also pertains to compositions, whose properties, stability and effectiveness is improved by adding plant essences.

The term “disinfectant” stands for substances or mixtures of substances for combating pathogenic microorganisms, or microorganisms that cause putrefaction, e.g. bacteria, viruses, fungus incl. spores. The goal of the application of the disinfectant in this case is to minimize the risk of an infection of humans or animals, or respectively to minimize the onset of putrefaction. Since some bacteria, molds, yeasts and viruses can lead to severe diseases, disinfection cannot be dismissed from the everyday life in the medical sector and private households. The importance of disinfection for the well being of humans is often underestimated. In previous centuries more people died as a result of the large epidemics (the plague, cholera, pox or the flu) than were killed during the wars. As late as the beginning of the 20^{th} century severe bacterial infections were often a deadly disease also in the industrialized nations. In the countries of the so-called third world even today infectious diseases, mostly stemming from inadequate hygienic situations, claim countless deaths. Therefore a high demand for effective and inexpensive disinfectants still exists, especially in the medical sector. But in the agrarian sector as well there is a high demand for e.g. fungicidal substances.

In order to obtain a highly disinfectant effect, in the past, above all, highly persistent chemical composites were used as disinfectants, which keep their disinfectant properties as long as possible, and therefore lead to an effective and long-lasting protection against microorganisms. But this leads to huge problems in respect to environmental aspects. The highly persistent disinfectants accumulate in the groundwater or respectively the food chain, and thereby lead to ecological and health problems. For example, ecological problems can arise, when disinfectants in high concentration reach biological wastewater treatment plants. In case of high concentrations of this disinfectant the microorganisms, which are necessary there, are affected in their growth, which can lead to a partial or complete failure of the wastewater treatment plant. Furthermore, persistent composites can accumulate in the sewage sludge. Especially the feed in of wastewater from clinks can lead to a dangerously high entry of disinfectant substances.

A further disadvantage of conventional disinfectants is the development of resistances. Resistant causative organisms survive the treatment with the disinfectant, and can pass on their resistance to so far non-resistant microorganisms via the transmittal of extra chromosomal genetic material. Disinfection of microorganisms, which have developed a resistance this way, can lead to severe diseases. While this problem can currently be observed mainly in the sectors of hospitals (hospitalism) and farm animals, one can fear that such problems in the future can also occur in the sector of private households, given the fact that disinfectants are more and more used in household cleaning agents.

In order to overcome the health and ecological disadvantages of such persistent disinfectants, the use of less dangerous substances has been considered in the past, especially the use of natural substances with potential for disinfectant properties. Here it has turned out to be a disadvantage that the disinfectant effect is weaker and/or less long lasting, so that the advantage of better environmental compatibility is gained in exchange for disadvantages in regards to effectiveness and protection from microorganisms. Since long-lasting effectiveness and reliable protection against microorganisms, especially in the medical sector, constitute the most important criteria though, less importance was awarded to such ecologically compatible disinfectants.

Given the illustrated state-of-the-art the invention at hand was based on the task to provide compositions, which have disinfectant properties and do not show the above illustrated disadvantages. In particular, the disinfectant compositions pursuant to this invention were supposed to show low toxicity, be ecologically compatible, therefore show no accumulation in the groundwater or food chain. In spite of these characteristics, the compositions pursuant to the invention are supposed to show strong and long-lasting disinfectant properties, and therefore offer reliable defense against microorganisms.

The stated task is solved by compositions, consisting of:
one or several disinfectant substances in the form of
   hydrogen peroxide, quaternary ammonium composites, peroxy acid, reaction products of coconut fatty acids with di-ethanol-amin, bronopol, 1,3-Didecyl-2 methylimidazolium chloride, alkyl di-azapentane, alkyl-amino-glycin, alkyl betaines, coco-betain-amidoamphopropionate, parabenes, sorbic acid, salts of the sorbic acid, esters of the sorbic acids and/or undecylenamide DEA;
one or several stabilizing substances in the form of
   L-ascorbic acid, hexadecane acid, stearic acid, urea, calcium acetate, sodium citrate, citric acid, fumaric acid, olein acid, potassic acetate, sodium acetate, lauric acid, di-sodium salt of citric acid, sodium bicarbonate, potassium bicarbonate, calcium carbonate, myristic acid, magnesium carbonate, magnesium stearate, zinc stearate, Calcium citrate, mono-potassic salt of citric acid, di-potassic salt of citric acid, tri-potassic salt of citric acid, potassium citrate, ammonium stearate, magnesium oxide, zinc oxide, calcium stearate, maleic acid, potassium chloride, magnesium sulfate, potassium bisulfate, sodium chloride, calcium citrate, di-sodium salt of sulfuric acid, sodium sulfate, potassium sulfate, cyclodextrines, glyceril monostearate, sorbitol, decamine oxide, PEG-4 monophenyl ether, PEG-20 glyceryl-oleoricinoleate, sorbic acid, sorbitane monolaurate, sorbitane monooleate, polyglycerol-4 oleate, cocamines, tridecyl alcoholen, lauryl alcohol, trideceth-9 and/or lactic acid.

Preferred quaternary ammonium compounds as disinfectant substances are thereby the quaternary ammonium compounds with the CAS-numbers 68391-01-5, 68424-85-1, 68424-95-3, 68989-01-5, 85409-22-9, 85409-23-0, 100085-64-1. Preferred peroxy acids as disinfectant solutions are e.g. peroxy acetic acid and peroxy benzoic acid. A preferred reaction product of coconut fatty acids with di-ethanolamine as disinfectant substance is the compound with the CAS-number 68440-04-0. Methyl-, ethyl- und propyl parabenes have proven to be especially favorable parabenes for the application as disinfectant substances.

It has been shown that by combining one or several disinfectant substances with one or several of the mentioned stabilizing substances a composition can be created, which on one hand does without the use of persistent and ecologically and respectively toxicologically questionable disinfectants, but on the other hand however displays a long-lasting disinfectant effect and offers a reliable defense against microorganisms.

Surprisingly, it has been shown that the disinfectant compositions pursuant to this invention does not only exhibit an unusually high stability in comparison to so far known, similarly put together disinfectants, but besides their excellent bactericidal effect also have very good fungicidal and virocidal properties.

An especially favored disinfectant composition is reached by mixing the following ingredients: H₂O₂, sodium benzoate, succinic acid, sorbic acid, ascorbic acid, peracetic acid and, if necessary, water for dilution. Especially good results were achieved when the mentioned components were used in the following weight proportions:
H₂O₂ 5-25 weight-%
Sorbic acid 0.1-5 weight-%
Ascorbic acid 0.3-10 weight-%
Peracetic acid 0.2-7.5 weight-%
Water on 100 weight-%

The disinfectant compositions pursuant to the invention are adequate for the immediate use on humans and animals as well as the use on surfaces and objects. An additional advantage exists in the fact that they can also be brought out via fumigation devices. Up to now the application of fungicidal compositions was not possible via fumigation devices. In use in the agrarian sector, in which the fungicidal effectiveness often is in the center of attention, a further advantage lies in the fact that, based on the ecological harmlessness and the low toxicity, the usual waiting period does not have to be observed until the products are suitable for consumption. An additional advantage exists in the fact that based on the ecological harmlessness of the used substances the application of the compositions pursuant to the invention can happen at any time, which makes it possible to apply at the time of the maximum biological effectiveness, therefore e.g. the maximum growth spurt of harmful fungi. With conventional agents this is often not possible, because strict rules concerning the time of application do exist.

The disinfectant compositions further have the advantage that they can be used without concern inside households without having to evacuate humans or animals. A further advantage exists in the fad that the compositions pursuant to the invention show a significantly lowered allergy potential compared to conventional disinfectants. This is especially important in the immediate application to the skin, especially, if the application occurs with people, who regularly come in contact with disinfectants, like e.g. hospital staff and cleaning crews. Furthermore, it was shown that the disinfectant composition pursuant to the invention does not lead to any noteworthy build-ups of resistances, which is a further advantage compared to the conventional disinfectants.

A further objective of the invention is the use of the named compositions as disinfectant.

Furthermore, object of the invention is also a composition, which, next ot the already mentioned ingredients, additionally contains reservatrol, usnic acid and/or one or more substances from the group of the humic acids.

Reservatrol is a natural material from the class of phytoalexins, which e.g. occurs in grapes. Usnic acid is a natural antibiotic agent, which is obtained from lichen varieties of the genus usnea. Surprisingly, it has been shown that the admixture of reservatrol and/or usnic acid further improves the disinfectant properties of the composition pursuant to the invention.

Humic acids are high-molecular chemical compounds, which form besides other humic substances during the decomposition of biological materials. This process is called humification. Humic acids are therefore a group of compounds. It has been shown, that bei adding the substance mixtures, which in the market are commonly known as humic acids, especially the disinfectant properties of the compositions pursuant to the invention can be significantly improved.

Furthermore, one object of the invention is also a composition, which, next to the already mentioned ingredients, additionally contains one or more insecticidal substances in the form of geraniol, castor oil, cinnamon oil, citric acid, citronelle oil, clove oil, corn oil, cotton seed oil, eugenol, garlic oil, geranium oil, lauryl sulfate, lemongrass oil, linseed oil, maleic acid, mint oil, peppermint oil, 2-phenethyl proprionate, sodium sorbate, rosemary oil, sesame oil, sodium lauryl sulfate, soybean oil, thyme oil, white pepper, octyl acid, decane acid, formic acid, propane-2-ol, rapeseed oil and/or lavandine oil.

It has been sown that adding sodium chloride to the composition can boost the insecticidal effect.

Through this combination a composition with insecticidal properties is created, which combines the advantages of biological insecticides with the ones of classic insecticides. Biological insecticides feature the advantage that they are easily accessible to the decomposition through microorganisms, and therefore do not accumulate in the groundwater or food chain. There is the disadvantage though that microorganisms cause a fast decomposition of the biological insecticides already during the storage of ready-made solutions and especially after application. With the insecticidal compositions pursuant to this invention this disadvantage is overcome by the fact that insecticidal substances, disinfectant substances, and stabilizing substances are adequately combined. The disinfectant substances in collaboration with the stabilizing substances thereby ensure that the biological insecticide in ready-made solution, e.g. in water, can be stored for long periods of time, even if water is used for the solution, which is microbially contaminated, which is often unavoidable in developing countries. A further advantage lies in the fact that a much higher stability of the applied biological insecticide is reached, so that the insecticide is protected from the biological decomposition by microorganisms at least for a while, without causing a long-term accumulation in the groundwater or food chain.

Furthermore, it has been shown that a further, significant improvement of the disinfectant and insecticidal properties of the composition pursuant to the invention can be reached, if one or more plant essences are added. It has turned out, that these plant essences can enhance the disinfectant and/or insecticidal properties, though they themselves have only shown to an insignificant extend to posess disinfectant and/or insecticidal properties. Without wanting to commit to a theory, the applicant assumes, that the improvement of the disinfectant and/or insecticidal properties by including specific plant essences at least is based on the fact, that those plant essences stabilize the composition pursuant to the invention to a significant extend, and thereby prolong ist period of effectivenss. Obviously, we have here a synergetic interaction with the other ingredients of the composition pursuant to the invention. The following plant essences have shown to be advantageous for the further improvement of the properties of the composition pursuant to the invention:
mentha piperita (peppermint), lavendula officinalis (lavender), rosa damascena (rose), calendula officinalis (calendula), hypericum perforatum (Saint-John's-Wort), achillea millefolium (milfoil), chamomilla matricaria (chamomile), urtica dioica (nettle) and/or betula pendula (common birch).

Typically, these plant essences, which are also called botanicals, are used pursuant to the invention as plant essences dissolved in alcohol. Alternatively, essences in butylene glycol-water-mixtures can alsol be used. Such essences can be commercially purchased. An example source of supply is: M & G Cosmetic Incorporation, 5 Forest Lane, East Quoque, N.Y. 11942.

It has proven to be especially advantageous, if the above mentioned plant essences are present in the compositions pursuant to the invention in the amount of 0.1-10 weight-%, particularly in the amount of 1-5 weight-%.

Such essences can be won e.g. via extraction from ground-up, crushed or kibbled leaves, stalks and stems or other parts of plants.

The insecticidal compositions pursuant to the invention do not show any toxicity, teratogenicity or cancerogenicity one should be concerned about. Furthermore, the insecticidal compositions pursuant to the invention take effect in terms of a contact poison, which means that the compositions do not penetrate e.g. fruits, but that the agents only take effect on the surface, where the insects are killed by coming into contact with the agents.

The insecticidal compositions pursuant to the invention are usually produces in the form of a concentrate. The application takes place after emulsification in water, or the use of water is forgone completely and the compositions are mixed by admixing other agents. The compositions can than be applied in any possible or preferred manner.

Optionally, the composition pursuant to the invention can in addition contain one or several emulsifying or dissolving substances in the form of glycerin, soybean oil, safflower oil, olive oil, linseed oil, cottonseed oil, corn oil, coconut oil, cod liver oil, castor oil, hydrogenated castor oil, peanut oil, sperm oil, cocoa, lecithin, malt extract, palm-oil, lanolin, wheat germ oil, sweet almond oil, sesame oil, hydrogenated soybean oil, soy lecithin, white mineral oil, molasses, hydrogenated cottonseed oil, hydrogenated palm-oils, rice bran oil, wheat oils, wintergreen oil, hydrogenated rapeseed oil, canola oil, cetyidimethiconcopolyol, PEG-20 glyceryloleoricinoleate, pentylene glycol, PEG-40, PEG-60, hydrogenated castor oil and/or propylene glycol.

Admixing the emulsifying and/or stabilizing substances can create a better homogeneity and a higher stability of the compositions.

Furthermore the compositions pursuant to the invention can facultatively include one or several moist-keeping agents, in the form of di-methiconpropyl PG-betaine, quaternium-80, dimethiconcopolyol, sterayidimethicon, cetyidimethicon, capraamidoalkylbetaine, sodium isooctylsulfate, sodium diisooctylsulfosuccinat, sodium di-octylsulfosuccinat and/or sodium salts of sulfosuccinates.

The sodium salts of di-propyl-, di-butyl-, di-pentyl-, di-hexyl-, di-heptyl-, di-octyl-, di-nonyl-und di-decyl-sulfosuccinates have proven to be especially advantageous sodium salts of sulfosuccinates as moist-keeping agents.

The moist-keeping agents have the function to enhance the moistening ability of the composition. This leads to the fact that the substrates treated with the composition can be moistened better, which in turn leads to an enhanced effectiveness.

A composition pursuant to the invention, which contains the following components: geraniol, PEG-20 glyceryl-oleoricinoleate, the reaction product of coconut fatty acids with di-ethanol-amide, isooctyl-sufosuccinat and soybean oil, has turned out to be an especially effective insecticidal composition. Especially good results were thereby reached, if the components were used in the following weight proportions:
10-30 weight-% geraniol,
5-25 weight.-% PEG-20 glyceryl-oleoricinoleate,
20-40 weight-% of the reaction product of coconut fatty acids with di-ethanolamide,
10-30 weight-% isooctyl-sulfosucchinat,
1-20 weight-% soybean oil.

As a further improved insecticidal composition a composition pursuant to the invention has turned out, containing the following components:

geraniol, PEG-20 glyceryl-oleoricinoleate, reaction product of coconut fatty acids with diethanolamide, isooctyl-sulfosucchinat, soybean oil, plant essences of mentha piperita (peppermint), lavendula officinalis (lavender), rosa damascena (rose), calendula officinalis (calendula), hypericum perforatum (Saint-John's-Wort), achillea millefolium (milfoil), chamomilla matricaria (chamomile), urtica dioica (nettle) and/or betula pendula (common birch).

It has been shown to be especially advantageous, if the named components are used in the following weight proportions:
10-30 weight-% geraniol,
5-25 weight-% PEG-20 glyceryl-oleoricinoleate,
20-40 weight- of the reaction product of coconut fatty acids with di-ethanolamide,
10-30 weight-% isooctyl-sulfosucchinat,
1-20 weight-% soybean oil,
0.1-1 weight-% of an essence of mentha piperita,
0.1-1 weight-% of an essence of lavendula officinalis,
0.1-1 weight-% of an essence of rosa damascena,
0.1-1 weight-% of an essence of calendula officinalis,
0.1-1 weight-% of an essence of hypericum perforatum,
0.1-1 weight-% of an essence of achillea millefolium,
0.1-1 weight-% of an essence of chamomilla matricaria,
0.1-1 weight-% of an essence of urtica dioica and/or
0.1-1 weight-% of an essence of betula pendula.

Optionally, the insecticidal compositions can additionally include one or several further gelatinizing substances in the form of paraffin wax, beeswax, honey, corn syrup, cellulose carboxymethylether, guar gum, carob gum, tracanth gum, pectin, gelatine, agar, cellulose carboxymethylether sodium salt, cellulose, cellulose acetate, dextrines, cellulose-2-hydroxyethylether, cellulose-2-hydroxypropylether, cellulose-2-hydroxypro-pylmethylester, cellulosemethylether, cornstarch, sodium alginate, maltodextrin, xanthan gum, epsilon-caprolactampolymer, diatomeen soil, acrylic acid polymers, PEG-30 glyceryl-cocoat, PEG-200 and/or hydrogenated glyceryl-palmitate.

A preferred acrylic acid polymer as gelatinizing substance is the acrylic acid polymer that is sold under the brand name Carbomer by the company Degussa.

By using gelatinizing agents a higher viscosity of the ready-made mixtures is achieved, which enables a better and longer lasting adhesion of the insecticidal compositions to the surface of the substrates to be treated.

The insecticidal compositions pursuant to the invention show a variety of advantages compared to pesticides known so far. Besides the advantages already mentioned above, it has turned out to be especially advantageous that the insecticidal composites pursuant to the invention allow the treatment of several types of pests at the same time. So far, this was only possible in a limited way, because e.g. insecticides and fungicides could typically not be mixed with each other. Therefore, further advantages here achieved here in terms of economy of time and improved profitability. Furthermore it turned out that the insecticidal composites pursuant to this invention do not lead to any noteworthy resistances.

Based on the above mentioned, especially advantageous properties of the compositions pursuant to the invention, particularly in regard to the strongly disinfectant and insecticidal properties combined with the ecological and toxicological inocuousness, as well as the high stability, the compositions are especially suited for the use in fighting pest insects in large areas. This is where the special advantage of the composition pursuant to the invention lies, because in contract to conventional agents it can be aplied to large areas without causing danger for the humans living in that area or danger of ecological damages. Here, the fight against locusts can be seen as a typical field of application, particularly the fight against locusts on the ground shortly after hatching, therefore before the dreaded formation of swarms.

The compositions pursuant to the invention can be deployed via fumigation, whereby the deployment typically is carried out in a dilution ration of 1:5 up to 1:500, particularly from 1:100 to 1:250.

A further object of the invention is the use of the above-described compositions as insecticide.

Furthermore, it has been shown that the composition pursuant to the invention also posesses an outstanding suitability as a repellent. Such repellents serve to repel insects. A common field of application of repellents is that of a preventative measure to repel insects in areas with a high risk of malaria infection. But also in areas without the threat of malaria the usage of repellents, e.g. for repelling of ticks, is often a wise precautionary measure.

Moreover, it has been shown that the described compositions can also be excellently be used to treat head lice (pediculi). By applying the compositions to the skin, hair and nails excellent treatment results can be achieved. This means that the compositions pursuant to the invention are also appropriate for the use as an active pharmaceutical substance. A method of treating head lice by applying the compositions pursuant to the invention, as well as the use of the compositions pursuant to the invention for the manufacture of a pharmaceutical composite for the treatment of head lice are in particular object of the invention.

Following, the invention is illustrated further by means of examples:

### EXAMPLE 1

### Production of a Disinfectant Composition

A disinfectant composition was produced by mixing the following ingredients:
H₂O₂ 15.00 weight-%
Sorbic acid 1.00 weight-%
Ascorbic acid 3.00 weight-%
Peracetic acid 2.75 weight-%
Water on 100 weight-%

The described composition has proven to be an excellent disinfectant during tests.

### EXAMPLE 2

### Production of an Insecticidal Composition

An insecticidal composition was produced by mixing the following ingredients in the declared weight proportions:
21 weight-% geraniol,
16 weight-% PEG-20 glyceryl-oleoricinoleate,
31 weight-% of the reaction product of coconut fatty acids with di-ethanolamide,
21 weight-% isooctyl-sulfosucchinat,
11 weight-% soybean oil.

The described composition has proven to be an excellent insecticide during tests.

### EXAMPLE 3

### Manufacturing of a Further Insecticidal Composition

An insecticidal composition was produced by mixing the following ingredients in the named weight percentages:
20.5 weight-% geraniol,
15 weight-% PEG-20 glyceryl-oleoricinoleate,
30 weight- of the reaction product of coconut fatty acids with di-ethanolamide,
20 weight-% isooctyl-sulfosucchinat,
10 weight-% soybean oil,
0.5 weight-% of an essence of mentha piperita,
0.5 weight-% of an essence of lavendula officinalis,
0.5 weight-% of an essence of rosa damascena,
0.5 weight-% of an essence of calendula officinalis,
0.5 weight-% of an essence of hypericum perforatum,
0.5 weight-% of an essence of achillea millefolium,
0.5 weight-% of an essence of chamomilla matricaria,
0.5 weight-% of an essence of urtica dioica and/or
0.5 weight-% of an essence of betula pendula.

The plant essences were obtained from the following source of supply: M & G Cosmetic Incorporation, 5 Forest Lane, East Quoque, N.Y. 11942

### EXAMPLE 4

### Execution of an Experiment in a Greenhouse Facility in Order to Ascertain the Insecticidal Properties

The insecticidal properties of the composition acording to example 3 were tested during an experiment in a greenhouse facility. The greenhouse facility in the experiment consisted of four greenhouses à 2.000 m² with a height of 4.5 m and one large greenhouse with a size of 12.000 m² and a height of 4 m.

The insecticidal composition was deployed via fumigation in a ratio 1:1 with a delution of 1:200. During the duration of the experiment fumigation took place 2×per week. It turned out that through fumigation already existing diseases caused by fungus or bacteria, as well as insect infestation were completely eliminated. Furthermore, no further infestation occurred during the whole duration of the experiment. Especially surprising was the fact that during the treatment also mildew, which typically infests the leaves of the plants, was successfully combatted. Such mildew infestation did occur before the use of the insecticidal compositions in a few unfavorable areas of the greenhouses, particularly in the wall rows and in climately unfavorable spots, e.g. the greenhouse exit. The infestation was fully cured by fumigation of the composition; no plant damage occurred.

1. A chemical composition, comprising:
one or several disinfectant substances in the form of
hydrogen peroxide, quaternary ammonium compounds, peroxy acids, reaction products of coconut fatty acids with diethanol amine, bronopol, 1,3-Didecyl-2 methylimidazolium chloride, alkyl di-azapentane, alkyl amino glycine, alkyl betaines, coco-betainamidoamphopropionate, parabenes, sorbic acid, salts of the sorbic acid, esters of the sorbic acids and/or undecylenamide DEA;
one or several stabilizing substances in the form of
L-ascorbic acid, hexadecane acid, stearic acid, urea, calcium acetate, sodium citrate, citric acid, fumaric acid, olein acid, potassic acetate, sodium acetate, lauric acid, di-sodium salt of citric acid, sodium bicarbonate, potassium bicarbonate, calcium carbonate, myristic acid, magnesium carbonate, magnesium stearate, zinc stearate, Calcium citrate, mono-potassic salt of citric acid, di-potassic salt of citric acid, tri-potassic salt of citric acid, potassium citrate, ammonium stearate, magnesium oxide, zinc oxide, calcium stearate, maleic acid, potassium chloride, magnesium sulfate, potassium bisulfate, sodium chloride, calcium citrate, di-sodium salt of sulfuric acid, sodium sulfate, potassium sulfate, cyclodextrines, glyceril monostearate, sorbitol, decamine oxide, PEG-4 monophenyl ether, PEG-20 glyceryl-oleoricinoleate, sorbic acid, sorbitane monolaurate, sorbitane monooleate, polyglycerol-4 oleate, cocamines, tridecyl alcoholen, lauryl alcohol, trideceth-9 and/or lactic acid.

2. The composition according to claim 1, characterized by the following composition:
H₂O₂ 5-25 weight-%
Sorbic acid 0.1-5 weight-%
Ascorbic acid 0.3-10 weight-%
Peracetic acid 0.2-7.5 weight-%
Water on 100 weight-%.

3. The composition according to claim 1, wherein the composition:
further comprises reservatrol, usnic acid and/or one or more substances from the group of humic acids.

4. The composition according to claim 1, further comprising:
one or several insecticidal components in the form of
geraniol, castor oil, cinnamon oil, citric acid, citronelle oil, clove oil, corn oil, cottonseed oil, eugenol, garlic oil, geranium oil, Lauryl sulfate, lemongrass oil, linseed oil, maleic acid, mint oil, peppermint oil, 2-phenethyl proprionate, potassium sorbate, rosemary oil, sesame oil, sodium lauryl sulfate, soybean oil, thyme oil, white pepper, octyl acid, decane acid, formic acid, propane-2-ol, rapeseed oil and/or lavandine oil.

5. The composition according to claim 1, wherein the composition additionally comprises
one or more plant extracts in the form of essences of mentha piperita (peppermint), lavendula officinalis (lavender), rosa damascena (rose), calendula officinalis (calendula), hypericum perforatum (Saint-John's-Wort), achillea millefolium (milfoil), chamomilla matricaria (chamomile), urtica dioica (nettle) and/or betula pendula (common birch).

6. The composition according to claim 1, wherein the composition additionally comprises:
one or several emulsifying and/or stabilizing substances in the form of
glycerin, soybean oil, safflower oil, olive oil, linseed oil, cottonseed oil, corn oil, coconut oil, cod liver oil, castor oil, hydrogenated castor oil, peanut oil, sperm oil, cocoa, lecithins, malt extract, palm-oil, lanolin, wheat germ oil, sweet almond oil, sesame oil, hydrogenated soybean oil, soy lecithin, white mineral oil, molasses, hydrogenated cottonseed oil, hydrogenated palm-oils, rice bran oil, wheat oils, wintergreen oil, hydrogenated rapeseed oil, canola oil, cetyldimethiconcopolyol, PEG-20 glyceryl-oleoricinoleate, pentylene glycol, PEG-40, PEG-60, hydrogenated castor oil and/or propylene glycol.

7. The composition according to claim 1, wherein the composition additionally comprises:
one or several agents, which keep moist, in the form of
di-methiconpropyl PG-betaine, quaternium-80, di-methiconcopolyol, sterayldimethicon, cetyldimethicon, capraamidoalkylbetaine, sodium isooctyl-sulfate, sodium diisooctylsulfosuccinat, sodium di-octylsulfosuccinat and/or sodium salts of sulfosuccinates.

8. The composition according to claim 4, characterized by the mixture:
10-30 weight-% geraniol,
5-25 weight-% PEG-20 glyceryl-oleoricinoleate,
20-40 weight-% of the reaction product of coconut fatty acids with di-ethanolamide,
10-30 weight-% isooctyl-sulfosucchinat,
1-20 weight-% soybean oil.

9. The composition according to claim 4, characterized by the composition:
10-30 weight-% geraniol,
5-25 weight-% PEG-20 glyceryl-oleoricinoleate,
20-40 weight-% of the reaction product of coconut fatty acids with di-ethanolamide,
10-30 weight-% isooctyl-sulfosucchinat,
1-20 weight-% soybean oil,
0.1-1 weight-% of an essence of mentha piperita,
0.1-1 weight-% of an essence of lavendula officinalis,
0.1-1 weight-% of an essence of rosa damascena,
0.1-1 weight-% of an essence of calendula officinalis,
0.1-1 weight-% of an essence of hypericum perforatum,
0.1-1 weight-% of an essence of achillea millefolium,
0.1-1 weight-% of an essence of chamomilla matricaria,
0.1-1 weight-% of an essence of urtica dioica and/or
0.1-1 weight-% of an essence of betula pendula.

10. The composition according to claim 1, wherein the composition additionally comprises:
one or more gelatinizing agents in the form of
paraffin wax, beeswax, honey, corn syrup, cellulose carboxymethylether, guar gum, carob gum, tracanth gum, pectin, gelatine, agar, cellulose carboxymethylether sodium salt, cellulose, cellulose acetate, dextrines, cellulose-2-hydroxyethylether, cellulose-2-hydroxypropylether, cellulose-2-hydroxypro-pylmethylester, cellulosemethylether, cornstarch, sodium alginate, maltodextrin, xanthan gum, epsilon-caprolactampolymer, diatomeen-soil, acrylic acid polymers, PEG-30 glyceryl-cocoat, PEG-200 and/or hydrogenated glyceryl-palmitate.

11. A method of disinfecting comprising applying the composition of claim 1 as a disinfectant to a surface or object to be disinfected.

12. A method of repelling insects comprising applying the composition of claim 1 as an insecticide.

13. (canceled)

14. The composition according to claim 1 further comprising a pharmaceutical excipient.

15. A method for the treatment of head lice comprising applying the composition of claim 1 to a human or animal in need thereof.

16. (canceled)
